(19) United States
(12) Patent Application Publication
(10) Pub. No.: US 2002/0088499 A1
(43) Pub. Date: Jul. 11, 2002

(54) Tear-out coupling

(76) Inventor: Scott Duncan, Santa Rosa, CA (US)

Correspondence Address: DERGOSITS & NOAH LLP, Four Embarcadero Center, Suite 1150, San Francisco, CA, 94111, US

(21) Appl. No.: 10/014,288

(22) Filed: Nov. 9, 2001

Related U.S. Application Data
(63) Continuation-in-part of application No. 09/401,252, filed on Sep. 23, 1999, now Pat. No. 6,267,001.
(60) Provisional application No. 60/101,758, filed on Sep. 25, 1998.

(51) Int. Cl. F16L 55/10

(52) U.S. Cl. 138/90; 138/89

(57) ABSTRACT

A unitary removable barrier for installation in a cylindrical water line to selectively block the water line to passage of water therethrough. The unitary removable barrier is composed of a single piece body having at least one cylindrical section sized to receive upstream and downstream pipes of the water line. A unitary planar disc molded with the cylindrical section is of a circular circumference and which completely blocks the water line but which is selectively removable from the cylindrical section thus removing the barrier to the passage of the water through the line. Tabs are provided on both the upstream and downstream sides of the planar disc to facilitate its removal from either the upstream pipe or downstream pipe.

### RELATED APPLICATIONS

The present application is a continuation-in-part of U.S. application Ser. No. 09/401,252, filed on Sep. 23, 1999, which is, in turn, a continuation of provisional application No. 60/101,758, filed on Sep. 25, 1998.

### TECHNICAL FIELD OF THE INVENTION

The present invention deals with a unitary removable barrier for installation in a cylindrical water line for temporarily blocking the passage of water through the line. When plumbing a structure such as a house intended to carry water, the structure goes through several waste line tests to confirm the integrity of the various plumbing joints. This requires temporarily blocking the waste line so that the water lines within the structure can be filled and leakes detected. The present invention involves an improved means of temporarily blocking the water waste line in order to create a suitable water head to conduct such testing.

### BACKGROUND OF THE INVENTION

When plumbing a structure such as a house, the structure is subjected to at least two different waste water tests. A first test is intended to determine the integrity of the water lines at ground or slab by filling the structure's waste lines with water to create a pressure head. A second test is conducted at “top-out” meaning that, after the structure is vented and tubs, sinks and other fixtures are installed, the waste lines are again filled with water to create yet another pressure head. Under pressure, the various lines are inspected for leakage prior to the installation of sheetrock which would obviously mask the detection of any leakage.

As background, plumbers are required to “stub out” or create an external waste line outlet two or three feet from the permimeter of the structural foundation. The “stub out” line is typically capped off in order to run the above-described water tests. There are a variety of currently available caps designed to accomplish this task. For example, a plumber may employ a rubber cap with a stainless steel band. However, a rubber cap is prone to being blown off of the “stub out” if subjected to sufficient water head pressure. In order to prevent this from occurring, the plumber will oftentimes drive a wooden stake in front of the rubber cap. This entails a good deal of additional effort and is not particularly effective in preventing blow-off. As an alternative, a plumber may glue the plastic test cap to the “stub out” which can be knocked off after the test has been conducted. However, this requires applying and setting a suitable adhesive which obviously must later be removed once the test has been completed. At removal, the plumber is likely to get quite wet as the water head pressure is released. There are additional problems associated with caps employed at “sub out.” For example, when a sewer line to the street or septic is about to be connected, the plumber is oftentimes not the party responsible for making the connection. If someone else makes the connection who is unfamiliar with this process, the cap will be cut off or otherwise removed releasing the water head within the structure perhaps prematurely before the plumber has had an opportunity to check the structure for leaks. Even if the plumber is the part responsible for connecting the sewer line to the “stub out,” he may still be forced to release his test and then recap the line after the connection has been made thus requring that the water head be restablished. This is time-consuming and also is a waste of water. Ideally, the plumber would like to maintain a water head throughout the sheetrock process so that any accidental nailing into the waste line would be visible by observing water leakage.

In addition to the above, once the sewer has been connected, it is traditional for the plumber to return to the project to reset his waste lines at which point a plumber employs a wye, a one-eighth bend and a clean-out plug at the point where the sewer has been connected. A plumber typically employs a long test ball which is inserted into the one-eighth bend and wye and is inflated at the appropriate position. The test ball is intended to temporarily block the waste line to again create a suitable pressure head within the structure. However, these test balls are extremely expensive and by reducing pressure within the test ball, they can be removed and oftentimes stolen from the job site. Further, they can inadvertently lose air, slip down the line and cause a major stoppage which must be dealt with by excavating and exposing the sewer line. The air balls, which exhibit external ribs, crack after repeated usage and tend to leak under tests. Leakage from the side wall of the test ball as well as from its air stem obviously result in water leakage to the sewer and reduction of water head thus reducing the effectiveness of the test.

One way of dealing with this issue has been disclosed in U.S. Pat. No. 5,507,501. The invention disclosed in the '501 patent is to a disk-shaped sealing device which is molded as an integral, unitary piece. The sealing device comprises a circular disc and an angled flange extending outwardly and upwardly from the perimeter of the circular disc. The disc-shaped device fits snugly within a barrel of a plastic fitting such that the circular disc is coaxially received in the barrel of the plastic fitting and the angled flange mates with and lies against a bevel in the barrel of the plastic fitting. A lug extends donwardly from the circular disc whereby first and second elongate grooves are formed in one of the surfaces of the disc. It is taught that the disc-shaped device can be ripped out of the barrel of the fitting so as to remove the device in its entirety from the fitting by pulling on the lug and ripping the circular disc along the first and second grooves in a spiral ripping motion that ultimately pulls the circular disc and the angled flange from the fitting.

Although the invention disclosed in the '501 patent constitutes a dramatic improvement over devices of the prior art described above, it, itself, is notwithout its limitations. Specifically, the disc-shaped sealing device must be employed only in a waste line which will accept an angled flange. As such, the device cannot be used when a water line is provided with a consistent and uniform interior diameter throughout its length. In addition, the disc-shaped sealing device must, itself, be sealed to the receiving ledge or flange of a waste line to ensure that the disc remains in sealing engagement with the water line during tests. This requires either the use of a glue or wax to ensure that the disc-shaped sealing device remains in place. It is hypothesized that these limitations have prevented the device described in the '501 patent from being universally accepted in the plumbing trade.

It is thus an object of the present invention to provide a means of temporarily blocking a “stub out” or water line which can effectively and temporarily prevent passage of water through the wase line thus creating a suitable pressure head within the structure while being easily removable from the waste line and while addressing all of the drawbacks recited above.

These objects will be more readily apparent when considering the following disclosure and appended drawings.

### SUMMARY OF THE INVENTION

The present invention is directed toward a unitary removable barrier for installation in a cylindrical water line to selectively block the water line to the passage of water therethrough. The unitary removable barrier is composed of a one-piece body having at least one cylindrical section having at least one cross-sectional area, longitudinal axis and sized to receive an upstream pipe and downstream pipe of the water line. The upstream pipe and downstream pipe are captured by said at least one cylindrical section either frictionally or by use of stainless steel bands. The unitary removable barrier includes a disc molded as a unitary structure with said at least one cylindrical section which is characterized as being of circular circumference and which completely blocks the water line when in place. The disc is provided with a diameter which is substantially perpendicular to the longitudinal axis and which is selectively removable from the cylindrical section both from the upstream pipe and downstream pipe thus removing the barrier to the water line.

### BRIEF DESCRIPTION OF THE DRAWINGS

FIG. 1 is a perspective view of one embodiment of a unitary removable barrier of the present invention.

FIG. 2 is a side plan view of the unitary removable barrier of FIG. 1.

FIG. 3 is a side cross sectional view of a second embodiment of the present invention.

FIGS. 4A and 4B are similar in view of FIG. 3 showing a further variation whereby magnets are employed to help retrieve pull cords used to remove the removable barrier after use.

FIG. 5 is a cross sectional view of yet another embodiment of the present invention.

### DETAILED DESCRIPTION OF THE INVENTION

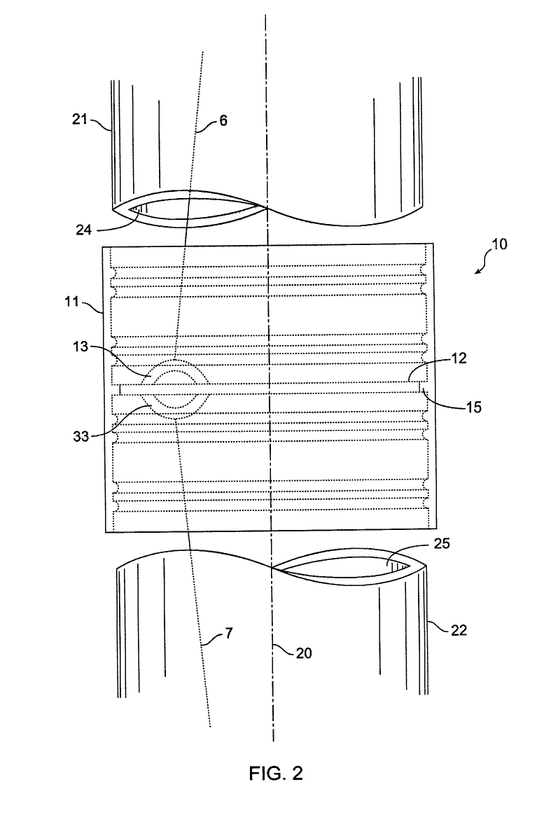

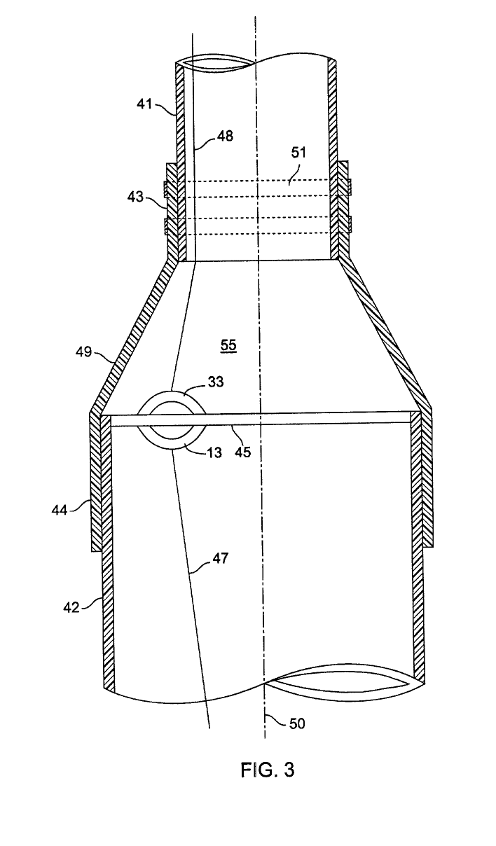

In referring to FIG. 2, pipes 21 and 22 comprise “sub out” or “clean out lines” which, as noted, extends from a house or other structure for connection to a sewer or septic line. In a first embodiment, the present invention is in the form of coupling 10 for placement between and to capture pipes 21 and 22 by frictionally receiving them within cylindrical section 11. In other words, the outer diameter of pipes 21 and 22 approximate inner diameter of cylindrical section 11 although the present invention contemplates the use of any well-known clamping means such as stainless steel bands 51 (FIG. 3) to ensure a watertight snug fit between cylindrical section 11 and pipes 21 and 22 along longitudinal axis 20.

The unitary removable barrier is composed of rubber, plastic or any moldable material. It is molded as a unitary article whereby a cylindrical section 11 and planar disc section 12 are of a single piece. In this regard, it is preferred that the planar face of disc 12 is substantially perpendicular to longitudinal axis 20 passing through upstream and downstream cylindrical water line 21 and 22. Again, as previously noted, as one embodiment, unitary removable barrier 10 is sized such that the inside diameter is cylindrical section 11 is to frictionally receive water lines 21 and 22 along longitudinal axis 20.

Planar disc 12 is intended to be removable when no longer needed to block the waste line under test. This is accomplished by providing first tab 13 and second tab 33 molded as unitary elements long the upstream face and downstream face of planar disc 12, respectively. The first and second tabs provide contact surfaces for pulling planar disc 12 along circumferential score line 14 to selectively remove the planar disc through either the upstream pipe or downstream pipe while employing cords 6 or 7 (FIG. 2). Although not shown, the planar disc can be withdrawn from the water through a wye or tee traditionally fabricated within such a line. Removal of disc 12 is carried out when hydraulic testing of the plumbing system of structure is no longer required. As such, when disc 12 is removed, the waste water line as established by pipes 21 and 22 is opened providing a free water path for the structure.

In a preferred embodiment of the present invention, it is noted that upon the removal of planar disc 12, a portion of the disc remains as defined by a ledge 15 of planar disc material. Ledge 15 is sized such that inner diameters 24 and 25 of cylindrical lines 21 and 22, respectively, coincide with the inner circumference of ledge 15 so that an uninterrupted substantially uniform inner pipe diameter is created thus minimizing any adverse effect that the present invention would otherwise have on the free flow of water through the subject waste line. Stated differently, when planar disc 12 is removed from cylindrical section 11, ledge 15 of the planar disc remains providing a circular opening with cylindrical section 11 substantially equal to inside diameters 24 and 25 of upstream and downstream pipes 21 and 22.

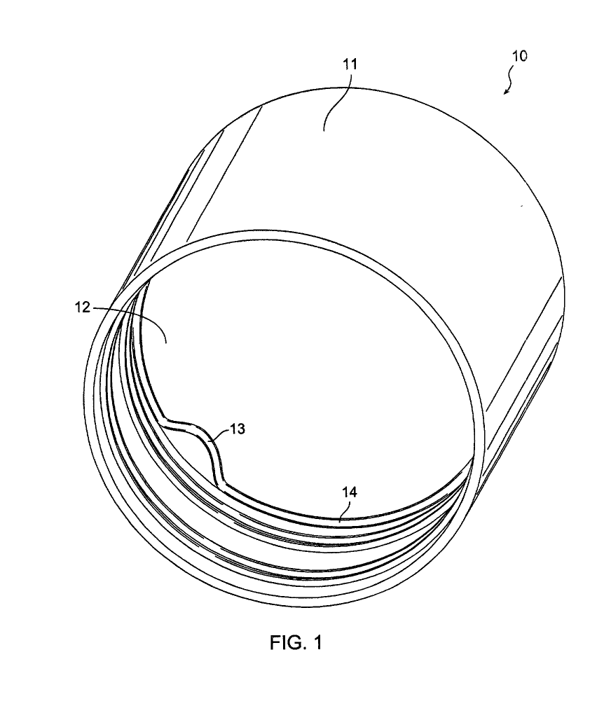

To summarize, although others have taught the use of removable blocking means to selectively prevent water from passing through a waste line in order to hydraulically test the plumbing of a structure, there have been no prior attempts to construct such an element which works as conveniently and which provides less obstruction as the invention disclosed herein and which is readily removable from both the upstream and downstream sides of the barrier. The present invention requires no gluing, waxing or other sealing means to attach the removable blocking disc to the waste water line. Further, in the embodiment show in FIGS. 1 and 2, upon its removal, the disc provides the line with an opening substantially equal to the inside diameter of the line itself. As such, there represents little or no obstruction to the line upon removal of the disc.

In a second embodiment, reference is made to FIG. 3. In this instance, it is commonplace, for example, to provide PVC pipe 41, eminating from a structure, to act as a wasteline for connection to PVC pipe 42 of a different, in this instance, larger diameter. In such an installation, coupling 49, again composed of a unitary molded article, is provided with upstream cylindrical section 43 of a first (smaller) diameter and a downstream cylindrical section 44 of a second (larger) diameter. Cylindrical sections 43 and 44 are connected by diagonally extending side wall 49 as shown.

As in the previous embodiment, cylindrical sections 43 and 44 of unitary article 40 can be sized to frictionally capture pipes 41 and 42, respectively, along longitudinal axis 50, thus obviating the need for any further coupling means. However, any suitable capturing device can further be employed such as stainless steel bands 51 to ensure a water tight and secure fitting.

Again, as in the previous embodiment, unitary removable barrier 45 molded as a unitary article to cylindrical sections 43 and 44 and transitional section 49 remains in place during test but is selective removable after a suitable water pressure test has been conducted. In doing so, pull cords 47 and 48, appended to molded tabs 13 and 33 is drawn through a wye or tee (not shown) traditionally found within the typical water waste line. The same groove or score line 14 shown in FIG. 1 can be fabricated within disc 45 circumferentially extending from tabs 13 and 33 along the side wall defined by cylindrical section 44. As such, planar disc 45 can be removed either upstream or downstream of such barrier.

As noted in the embodiment shown in FIG. 3, PVC pipes 41 and 42 do not abut one another although, ideally, pipe 42 is caused to abut removable disc 45. As such, the unitary removable barrier 40 as depicted in FIG. 3 acts to retain pipes 41 and 42 in a pre-determine orientation whereby void space 55 remains between the end of each pipe length.

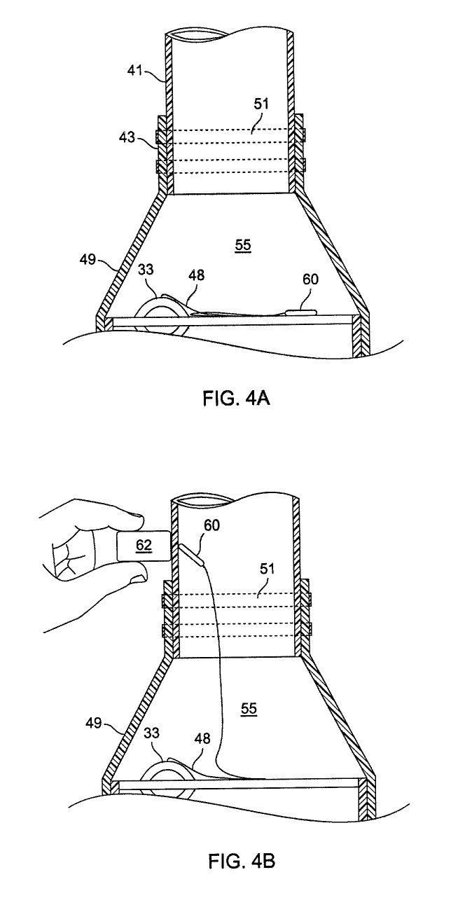

As noted once the subject hydraulic testing has been completed, a user would pull on either cords 47 or 48 to remove the subject disc 45. However, in the field, it is not always convenient to insure that the terminal ends of the cords remain external to the waste lines. When such cords fall back into the waste line, it can be inconvenient to recapture them for later use. In dealing with this issue, it is proposed that magnet 60 be attached to a pull cord such as pull cord 48 (FIG. 4A) which can reside loosely upon disc 45 until needed. When the user intends to remove disc 45 after testing, pull cord 48 can be drawn from disc 45 by use of an externally applied magnet 62 (FIG. 4B).

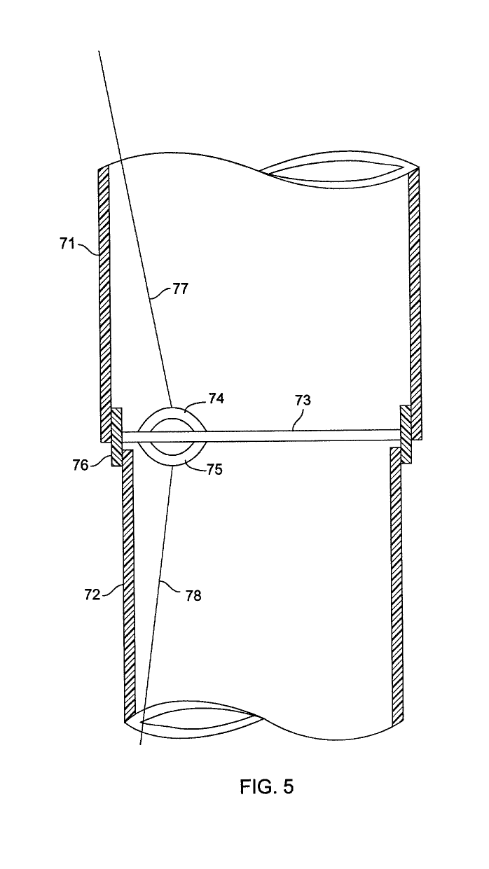

Another variation of the present invention is depicted in FIG. 5. In this instance, planar disc 73 is again shown with tabs 74 and 75 for its possible removal either upstream or downstream of planar disc 73 after hydraulic testing of the waste line via pull cords 77 and 78, respectively. In this instance, however, cylindrical side walls fit internally of pipe 71 making for a much more compact orientation than that shown in FIG. 3. The unitary removable barrier still acts as a coupling for connecting pipes 71 and 72, but acts as a male member to pipe 71 and female member to pipe 72.

I claim:

1. A unitary removable barrier for installation in a cylindrical water line to selectively block the water line to passage of water therethrough, said unitary removable barrier being composed of a single piece body having at least one cylindrical section having at least one cross-sectional area, longitudinal axis and sized to receive an upstream pipe and downstream pipe of said water line, and a planar disc molded with said at least one cylindrical section and which is characterized as being of circular circumference which completely blocks said cross-sectional area, having a diameter which is substantially perpendicular to said longitudinal axis and which is selectively removable from said cylindrical section both from said upstream pipe and downstream pipe thus removing said barrier to said water line.

2. The unitary removable barrier of claim 1 wherein when said planar disc is removed from said cylindrical section, a ledge of said planar disc remains providing a circular opening within said cylindrical section substantially equal to the inside diameters of said upstream and downstream pipes.

3. The unitary removable barrier of claim 1 wherein said planar disc is provided with at least one score line to facsilitate its removal from said cylindrical section.

4. The unitary removable barrier of claim 3 wherein said at least one score line comprises a score line at the circumference of said planar disc.

5. The unitary removable barrier of claim 1 wherein said planar, disc is characterized as having an upstream face and downstream face and a first tab molded to said upstream face and a second tab molded to said downstream face whereby said planar disc is removable as a barrier to said cylindrical water line by applying sufficient pulling force on either tab to separate said planar disc from said at least one cylindrical section.

6. The unitary removable barrier of claim 5 wherein said first and second tabs are molded to said upstream face and downstream face of said planar disc, respectively, along score lines configured within said planar disc.

7. The unitary removable barrier of claim 6 wherein a pull line is appended to said planar disc which extends outside of said cylindrical water line such that by pulling on said pull line, said planar disc ruptures along said score line whereupon said planar disc is removable from said water line.

8. The unitary removable barrier of claim 7 wherein said pull line is appended to either or both said first or second tab.

9. The unitary removable barrier of claim 2 wherein said at least one cylindrical section is designed to frictionally receive said upstream pipe and downstream pipe of said water line.

10. The uniting removable barrier of claim 1 wherein said upstream pipe and said downstream pipe substantially abut on another at said unitary removable barrier.

11. A unitary removable barrier for installation in a cylindrical water line to selectively block the water line to passage of water therethrough, said unitary removable barrier being composed of a single piece body having a cylindrical section having a cross-sectional area, longitudinal axis and sized to frictionally receive an upstream pipe and downstsream pipe of said water line, each of said pipes having substantially equal inside diameters, said upstream pipe and said downstsream pipe substantially abutting one another at a planar disc molded with said cylindrical section which is characterized as being of circular circumference which completely blocks said cross-sectional area, having a diameter which is substantially perpendicular to said longitudinal axis and which is selectively removable from said cylindrical section both from said upstream pipe and downstream pipe thus removing said barrier to said water line.

12. A unitary removable barrier for installation in a cylindrical water line to selectively block the water line to passage of water therethrough, said unitary barrier being composed of a single piece body having a first cylindrical section of first diameter and a second cylindrical section of a second diameter and a longitudinal axis passing through both first and second cylindrical sections, said first cylindrical section sized to receive an upstream pipe and said second cylindrical section sized to receive a downstream pipe of said water line and, when said upstream pipe and said downstream pipe are received, respectively, by said first and second cylindrical sections, a disc molded as a unitary piece with said first and second cylindrical sections is positioned between said upstream pipe and downstream pipe to completely block said water line to the passage of water between said upstream pipe and downstream pipe, said disc being completeley removable from said water line both from said upstream pipe and down stream pipe.

13. The unitary removable barrier of claim 12 wherein said disc is characterized as having a diameter substantially equal to the diameter of said downstream pipe.

14. The unitary removable barrier of claim 10 wherein said disc is provided with at least one score line to facilitate its removal from said water line.

15. The unitary removable barrier of claim 6 wherein a pull line is appended at one end to said planar disc and is appended to a magnet at its other end.
